(19) United States
(12) Patent Application Publication
(10) Pub. No.: US 2024/0339953 A1
(43) Pub. Date: Oct. 10, 2024

(54) System and Method for Complementarily Coupling and Orderly Converting Multi-energy

(71) Applicant: Zhejiang University, Hangzhou, Zhejiang Province (CN)

(72) Inventors: Gang Xiao, Hangzhou, Zhejiang Province (CN); Anwei Sun, Hangzhou, Zhejiang Province (CN); Haoran Xu, Hangzhou, Zhejiang Province (CN)

(21) Appl. No.: 18/578,498

(22) PCT Filed: Jul. 6, 2022
(86) PCT No.: PCT/CN2022/104066

§ 371 Date: Jan. 11, 2024

(30) Foreign Application Priority Data
Jul. 12, 2021 (CN) 202110786233.9

(51) Int. Cl. H02S 10/30; C10J 3/72; C10L 3/08; H01M 8/0612; H01M 8/0656; H01M 8/12; H01M 8/1246; H01M 8/18

(52) U.S. Cl. CPC H02S 10/30; C10J 3/721; C10L 3/08; H01M 8/0643; H01M 8/0656; H01M 8/1246; H01M 8/186; C10J 2300/0916; C10J 2300/0936; C10L 2200/0469; C10L 2290/04; C10L 2290/38; H01M 2008/1293

(57) ABSTRACT

A system and method for complementarily coupling and orderly converting multi-energy. The system includes: a reversible solid oxide cell, a gasification reaction chamber, synthesis reactor, and photo-thermal coupled catalytic reactor. Gasification of biomass/coal provides synthesis gas of a first source; feedstock gas is electrolyzed to produce synthesis gas of a second source; the synthesis gas of a first source and the synthesis gas of a second source react in the synthesis reactor to produce hydrocarbon fuel; during power generation, the synthesis gas enters a fuel electrode to react, and gas flowing out of the fuel electrode passes through the photo-thermal coupling catalytic reactor to react to produce hydrocarbon fuel; a heat source and light source required for gasification, electrolysis, power generation and photo-thermal coupled catalysis are provided by solar energy, and electrical energy for electrolysis is provided by power of unstable renewable energy from abandoned wind and light.

### TECHNICAL FIELD

The present disclosure relates to the technical field of clean energy, in particular to, a system and method for complementarily coupling and orderly converting multi-energy.

### BACKGROUND ART

Fossil energy is a kind of hydrocarbon or its derivatives. It is derived from deposition of fossils of ancient organisms and is primary energy. Any incomplete combustion of fossil fuels emits toxic gases. With the massive consumption of traditional fossil energy, environmental problems are becoming more and more prominent, and people pay widespread attention to the development of renewable energy, which can reduce the dependence on fossil energy and meet the demand for sustainable energy. At the same time, global warming caused by high levels of carbon dioxide in the atmosphere requires effective carbon dioxide control strategies.

Solar energy, as the clean energy with the richest reserves, is the focus of development of renewable energy in the future, but at the same time there are disadvantages such as instability, and stable heat sources are output by means of light condensation, heat collection and heat storage so that solar energy can be more effectively utilized. Biomass is a kind of ideal renewable energy, it is widely distributed, huge in quantity, and low in pollution, but also has the disadvantage of low energy density, and through the biomass gasification technology, it can be transformed into the form of high-grade energy. The use of the renewable energy is of great benefit to improve the environment of acid rain and reduce the amount of carbon dioxide in the atmosphere, thus mitigating the “greenhouse effect”.

The reversible solid oxide cell (referred to as rSOC) is a promising energy conversion device that, when used as an electrolytic cell, converts excess renewable energy into CO/H2 synthesis gas through CO2/H2O co-electrolysis. It provides a method for producing synthesis gas using captured carbon dioxide, combining production of the synthesis gas with a system for producing synthetic fuel to synthesize high energy density fuels such as various hydrocarbons; when used as a cell, it is capable of introducing CO/H2 synthesis gas and outputting stable electric energy. This technology can realize the recycling of CO2, alleviate the greenhouse effect, and also participate in peak regulation, which is of great significance for building a low-carbon society.

At present, biomass gasification suffers from complex biomass sources, high gasification energy consumption, unstable in product quality and the like, resulting in the low added value of biomass conversion products, which is not conducive to the extensive utilization of biomass. rSOC suffers from difficulties in thermal management, low utilization rate of reaction components and poor economical efficiency, and the electrical and thermal energy input of most rSOC during electrolysis comes from fossil energy, which does not realize production of green fuel from the source. The problems of high volatility, difficulty in peak and frequency regulation, and high cost of energy storage of the renewable electric energy have seriously restricted the development of clean energy. At present, light condensation and heat collection of the solar energy are still centered on the power generation method of thermal engineering conversion, lacking an orderly conversion method coupled with thermochemistry/electrochemistry/photochemistry, which makes it difficult to achieve further improvement of energy efficiency and energy economy.

### SUMMARY OF THE DISCLOSURE

In response to the above problems, the present disclosure provides a system and method for complementarily coupling and orderly converting multi-energy. Based on high-temperature heat collection and heat storage of solar energy, in combination with the technical means of biomass/coal airless gasification, high-temperature solid oxide electrolysis hydrogen production/fuel cell power generation, hydrocarbon fuel photo/thermal catalytic synthesis and the like, through the complementary coupling of thermochemistry/electrochemistry/photochemistry, unstable and disorderly renewable electric energy, biomass energy from disorderly sources and solar energy disorderly in time are converted into stable hydrocarbon fuel and electric energy, to achieve the complementary “zero carbon emission” orderly conversion of renewable energy and fossil energy.

A system for complementarily coupling and orderly converting multi-energy includes: a gasification reaction chamber, the gasification reaction chamber providing synthesis gas of a first source through a gasification reaction of biomass/coal; a reversible solid oxide cell, an inlet of a fuel electrode of the reversible solid oxide cell being connected to a feedstock gas supply device, where during electrolysis, feedstock gas is electrolyzed at the fuel electrode to produce synthesis gas of a second source; a synthesis reactor, the synthesis gas of a first source and the synthesis gas of a second source reacting in the synthesis reactor to produce hydrocarbon fuel; and a photo-thermal coupled catalytic reactor, during power generation, the photo-thermal coupled catalytic reactor being connected to an outlet of the fuel electrode of the reversible solid oxide cell, an outlet of the gasification reaction chamber being connected to the inlet of the fuel electrode, and gas flowing out of the fuel electrode passing through the photo-thermal coupled catalytic reactor to react to produce hydrocarbon fuel; where a heat source required for the gasification reaction chamber and the reversible solid oxide cell, and a heat source and light source required for the photo-thermal coupled catalytic reactor are provided by solar energy, and electrical energy required for electrolysis of the reversible solid oxide cell is provided by power of unstable renewable energy from abandoned wind and light.

The biomass energy and the solar energy belong to energy which is widely distributed and rich in source, but the energy density is low; it is difficult to consume renewable electric energy from abandoned wind and light. According to the technical solution, the solar energy and the power of unstable renewable energy from abandoned wind and light provide thermal energy and electrical energy required for electrolysis of the reversible solid oxide cell; the problem that the electrical energy and thermal energy input of the existing rSOC is provided by fossil energy, abandoning wind and light is solved. The solar energy provides the heat required for the gasification reaction of biomass/coal, solving the technical problems of high energy consumption for gasifying and converting biomass into synthesis gas and the low hydrogen to carbon ratio of the synthesis gas, and realizing the production of clean synthesis gas. The biomass energy, the solar energy and the power of unstable renewable energy from abandoned wind and light are complementarily coupled, and orderly converted into hydrocarbon fuel.

Further, in an optional technical solution of the present disclosure, an oxygen-rich air storage tank and an oxygen-poor air storage tank are further included, where during electrolysis, air flows from an outlet of the oxygen-poor air storage tank into the oxygen-rich air storage tank via an oxygen electrode; during power generation, air flows from an outlet of the oxygen-rich air storage tank into the oxygen-poor air storage tank via the oxygen electrode.

According to the technical solution, during electrolysis, air is introduced at the oxygen electrode through the oxygen-poor air storage tank, which can purge the oxygen produced on the surface of the oxygen electrode, lower an oxygen precipitation reaction overpotential, reduce the electrical energy consumption, and regulate the cell temperature according to the heat absorption and release state of the reversible solid oxide cell; during power generation, air is introduced at the oxygen electrode through the oxygen-rich air storage tank, and oxygen in the air can have an electrochemical reaction.

According to the technical solution, the oxygen-rich air storage tank and the oxygen-poor air storage tank are disposed at the oxygen electrode, which can conveniently and quickly control the air into the reversible solid oxide cell, provide oxygen-poor and oxygen-rich conditions, and improve the convenience of operating the system and switching modes.

Further, in an optional technical solution of the present disclosure, the feedstock gas includes water vapor and carbon dioxide.

The feedstock gas supply device includes a steam generator, a CO2 storage tank and a feedstock gas mixing chamber, the steam generator and the CO2 storage tank are connected to the feedstock gas mixing chamber, respectively, and a water vapor flow meter, a CO2 flow meter and a feedstock gas flow meter are connected to an outlet pipeline of the steam generator, the CO2 storage tank and the feedstock gas mixing chamber.

According to the technical solution, the steam generator is used for providing water vapor, the CO2 storage tank is used for providing CO2, the feedstock gas mixing chamber is used for mixing water vapor and CO2, and the water vapor flow meter, the CO2 flow meter and the feedstock gas flow meter are disposed to conveniently control the ratio of water vapor/CO2 and the flow of the feedstock gas into a solid oxide electrolytic cell.

Further, in an optional technical solution of the present disclosure, coal in the biomass/coal includes solid fossil fuels such as low-quality coal, and biomass in the biomass/coal includes straw, wood chips, rice husk or tree branches.

According to the technical solution, the addition of coal as an auxiliary material can, on the one hand, compensate for the shortage of biomass feedstock due to seasonal differences and meet the long-term stable operation of the system, and on the other hand, improve the stability of the quality of gasification products and meet the requirements of controllability and optimization of the coupling process of a multi-reaction system. Straw, wood chips, rice husk or tree branches are all renewable energy, and the use of the renewable energy is conducive to protecting the environment, coping with climate change, realizing green production, and conforming to the concept of sustainable development.

Further, in an optional technical solution of the present disclosure, a gas purification device and a synthesis gas storage tank are further included.

The gas purification device is used for absorbing CO2 and H2O, and an inlet of the gas purification device is connected to the outlet of the gasification reaction chamber, and an outlet of the gas purification device is connected to a first inlet of the synthesis gas storage tank.

During electrolysis, a second inlet of the synthesis gas storage tank is connected to the outlet of the fuel electrode, and during power generation, at least one outlet of the synthesis gas storage tank is connected to the inlet of the fuel electrode.

According to the technical solution, the gas purification device is disposed, which can remove CO2 and H2O mixed in the synthesis gas, and is conducive to improving the purity of the synthesis gas. Disposing the synthesis gas storage tank makes it convenient to store the produced synthesis gas of a first source and synthesis gas of a second source for standby use, which improves convenience.

Further, in an optional technical solution of the present disclosure, the number of the reversible solid oxide cell can be from 1 to more, and when the number of the reversible solid oxide cell is greater than 1, the reversible solid oxide cells are connected to the synthesis gas storage tank in series or in parallel.

According to the technical solution, the plurality of reversible solid oxide cells are disposed to enable simultaneous production of the synthesis gas, which is conducive to improving the yield and production efficiency of the synthesis gas and reducing the complexity of the system of the present disclosure.

Further, in an optional technical solution of the present disclosure, the power of unstable renewable energy from abandoned wind and light is provided by a power grid, the power grid includes an input pipeline and an output pipeline, the output pipeline is provided with a first electrical switch, the input pipeline is provided with a second electrical switch, and the first electrical switch controls the on/off of the power of unstable renewable energy from abandoned wind and light to electric energy delivered to the reversible solid oxide cell; and the second switch controls the on/off of the output of the electrical energy when the reversible solid oxide cell generates power.

According to the technical solution, the input pipeline, the output pipeline, the first electrical switch and the second electrical switch are disposed such that the electrical energy can be conveniently provided to the reversible solid oxide cell, and the produced electrical energy can also be conveniently used for peak regulation of the power grid, improving the utilization rate of energy.

Further, in an optional technical solution of the present disclosure, solar energy is provided through a solar light condensation, heat collection and heat storage device, and the solar light condensation, heat collection and heat storage device is in a tower, tank or butterfly type.

According to the technical solution, the solar light condensation, heat collection and heat storage device can achieve high-grade storage of fluctuating solar energy, and can further achieve the controlled release of thermal energy and the optimization of energy flow within a composite system through the thermochemical process, providing a suitable temperature for each reaction. The solar light condensation, heat collection and heat storage device can be freely selected as the tower, tank or butterfly type, improving the flexibility for setting the conversion system.

Further, in an optional technical solution of the present disclosure, a fuel storage tank is further included, an outlet of the photo-thermal coupled catalytic reactor and an outlet of the synthesis reactor being respectively connected to the fuel storage tank.

According to the technical solution, by disposing the fuel storage tank, the produced hydrocarbon fuel can be conveniently stored for use as needed.

The present disclosure further provides a conversion method of the system for complementarily coupling and orderly converting multi-energy, including the following steps:
a synthesis gas production step, the gasification reaction chamber providing synthesis gas of a first source through gasification of biomass/coal, and heat required for the gasification of the biomass/coal being provided by solar energy; a reversible solid oxide cell being used as an electrolysis cell, power of unstable renewable energy from abandoned wind and light and solar energy respectively providing electrical energy and thermal energy required for electrolysis of the reversible solid oxide cell, and feedstock gas having an electrochemical reaction at the fuel electrode to produce synthesis gas of a second source; and
a hydrocarbon fuel production step, the synthesis gas of a first source and the synthesis gas of a second source reacting in the synthesis reactor to produce hydrocarbon fuel; the reversible solid oxide cell being used as a cell, the synthesis gas of a first source and/or the synthesis gas of a second source having an electrochemical reaction at the fuel electrode and a produced product reacting with unreacted synthesis gas by entering the photo-thermal coupled catalytic reactor to produce hydrocarbon fuel; a heat source and light source required for the photo-thermal coupled catalytic reactor being provided by the solar energy.

### DESCRIPTION OF THE DRAWINGS

FIG. 1 is a structural schematic view of a system for complementarily coupling and orderly converting multi-energy.

FIG. 2 is a structural schematic view of a reversible solid oxide cell of the present disclosure.

FIG. 3 is a structural schematic diagram showing electrolysis of the system for complementarily coupling and orderly converting multi-energy during electrolysis of the reversible solid oxide cell of the present disclosure.

FIG. 4 is a structural schematic diagram showing power generation of the system for complementarily coupling and orderly converting multi-energy during power generation of the reversible solid oxide cell of the present disclosure.

### LIST OF REFERENCE NUMERALS

1—reversible solid oxide cell; 11—oxygen electrode; 12—fuel electrode; 13—electrolyte; 2—feedstock gas supply device; 21—steam generator; 211—water vapor flow meter; 22—CO2 storage tank; 221—CO2 flow meter; 23—feedstock gas mixing chamber; 231—feedstock gas flow meter; 3—synthesis gas supply device; 31—gasification reaction chamber; 32—gas purification device; 33—synthesis gas storage tank; 4—synthesis reactor; 5—photo-thermal coupled catalytic reactor; 51—mixed gas switch; 6—solar light condensation, heat collection and heat storage device; 7—power grid; 71—first electrical switch; 72—second electrical switch; 81—oxygen-rich air storage tank; 82—oxygen-poor air storage tank; and 9—fuel storage tank.

### DETAILED DESCRIPTION

The technical solutions in embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments in the present disclosure without creative efforts shall fall within the protection scope of the present disclosure.

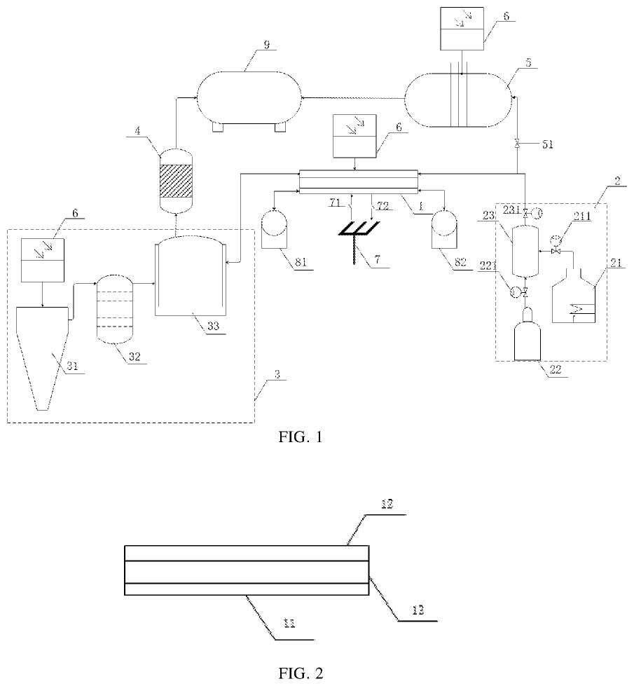

As shown in FIG. 1, the present disclosure provides a system for complementarily coupling and orderly converting multi-energy, including: a reversible solid oxide cell 1, a feedstock gas supply device 2, a synthesis gas supply device 3, a synthesis reactor 4, a photo-thermal coupled catalytic reactor 5, solar energy and power of unstable renewable energy from abandoned wind and light, where
the synthesis gas supply device 3 includes a gasification reaction chamber 31, the gasification reaction chamber 31 providing synthesis gas of a first source through a gasification reaction of biomass/coal;
during electrolysis, an inlet of a fuel electrode 12 of the reversible solid oxide cell 1 is connected to the feedstock gas supply device 2, the feedstock gas supply device 2 is used for providing feedstock gas, and synthesis gas of a second source is produced when the feedstock gas is electrolyzed at the fuel electrode 12; the synthesis gas of a first source and the synthesis gas of a second source react in the synthesis reactor 4 to produce hydrocarbon fuel;
during power generation, an outlet of the synthesis gas supply device 3 is connected to the inlet of the fuel electrode 12 of the reversible solid oxide cell 1; the photo-thermal coupled catalytic reactor 5 is connected to an outlet of the fuel electrode 12, and gas flowing out of the fuel electrode 12 passes through the photo-thermal coupled catalytic reactor 5 to react to produce hydrocarbon fuel;
a heat source required for the gasification reaction chamber 31 and the reversible solid oxide cell 1, and a heat source and light source required for the photo-thermal coupled catalytic reactor 5 are provided by the solar energy, and electrical energy required for electrolysis of the reversible solid oxide cell 1 is provided by the power of unstable renewable energy from abandoned wind and light.

In the above way, biomass/coal gasifies by providing a stable heat source via the solar energy to be converted into synthesis gas and then converted into hydrocarbon fuel with a high added value, such as methanol. The reversible solid oxide cell 1 uses the electric energy provided by the power of fluctuating renewable energy from abandoned light and wind and the stable heat source provided by the solar energy to electrolyze feedstock gas (CO2/H2O), converting the feedstock gas into the synthesis gas and then into the hydrocarbon fuel with a high added value, which realizes the recycling of CO2 and alleviating the greenhouse effect. The reversible solid oxide cell can also use the synthesis gas produced by biomass/coal gasification and the stable heat source provided by the solar energy to produce stable electric energy, and the gas produced is converted into the hydrocarbon fuel by optical/thermal synergistic catalysis through the photo-thermal coupled catalytic reactor 5 with zero carbon emission of the whole system, which can orderly convert biomass energy, solar energy and fluctuating electric energy into high-density energy for storage, improving the conversion efficiency for energy utilization and promoting development of clean energy.

When solar energy is used to provide thermal energy, compared with the use of fossil fuel to provide thermal energy, solar energy as a kind of clean energy, is inexhaustible, will not produce waste gas, waste water and waste residue, is green and non-polluting, and can reduce the production cost of the synthesis gas, and improve the production benefit. The use of the power of unstable renewable energy from abandoned light and wind is conducive to alleviating the problem of abandoning wind and light, and the power of unstable renewable energy from abandoned wind and light can also be stored in the form of the high-density hydrocarbon fuel to reduce the cost of energy storage.

The solar energy of the present disclosure provides the heat required for the gasification reaction of the biomass/coal, and the catalytic co-gasification of the biomass/coal in the gasification reaction chamber 31 can produce a certain proportion of gaseous fuel such as CO and H2, and there is no combustion section for supplying heat in the gasification reaction chamber 31 under photo-thermal conditions, so there is no need to fully provide oxygen, and the content of CO2 in the product gas is as low as 4 vol %, and the H/C ratio of the effective produced gas is about 2.5:1, which effectively increases the H/C ratio of the synthesis gas, facilitates the synthesis of the hydrocarbon fuel such as methanol, solves the technical problems of high energy consumption and low hydrogen to carbon ratio of synthesis gas when biomass gasifies to be converted into the synthesis gas, and realizes the production of clean synthesis gas. The solar energy and the power of unstable renewable energy from abandoned wind and light provide thermal energy and electrical energy required for electrolysis of the reversible solid oxide cell 1, which solves the problem that the energy consumption is high during electrolysis of the reversible solid oxide cell 1. By coordinating the biomass energy, solar energy, and power of unstable renewable energy from abandoned wind and light, the present disclosure achieves the conversion of unstable and disorderly renewable electric energy, biomass energy from disorderly sources, and solar energy disorderly in time into the stable hydrocarbon fuel and electrical energy, and realizes low-cost and high-energy density storage of the biomass energy, solar energy, and fluctuating electrical energy.

Specifically, an oxygen-rich air storage tank 81 and an oxygen-poor air storage tank 82 are further included, where during electrolysis, air flows from an outlet of the oxygen-poor air storage tank 82 into the oxygen-rich air storage tank 81 via an oxygen electrode 11; during power generation, air flows from an outlet of the oxygen-rich air storage tank 81 into the oxygen-poor air storage tank 82 via the oxygen electrode 11.

During electrolysis, air is introduced at the oxygen electrode 11 through the oxygen-poor air storage tank 82, which can purge the oxygen produced on the surface of the oxygen electrode 11, lower an oxygen precipitation reaction overpotential, reduce the electrical energy consumption, and regulate the cell temperature according to the heat absorption and release state of the reversible solid oxide cell 1; during power generation, air is introduced at the oxygen electrode 11 through the oxygen-rich air storage tank 81, and oxygen in the air can have an electrochemical reaction.

In the above way, the oxygen-rich air storage tank 81 and the oxygen-poor air storage tank 82 are disposed at the oxygen electrode 11, which can conveniently and quickly control the air into the reversible solid oxide cell 1, provide oxygen-poor and oxygen-rich conditions, and improve the convenience of operating the system and switching modes.

Specifically, the feedstock gas includes water vapor and carbon dioxide. The feedstock gas supply device 2 includes a steam generator 21, a CO2 storage tank 22 and a feedstock gas mixing chamber 23, the steam generator 21 and the CO2 storage tank 22 are respectively connected to the feedstock gas mixing chamber 23, and a water vapor flow meter 211, a CO2 flow meter 221 and a feedstock gas flow meter 231 are connected to an outlet pipeline of the steam generator 21, the CO2 storage tank 22 and the feedstock gas mixing chamber 23, respectively.

The present disclosure adopts CO2 as the feedstock gas, which is conducive to the recycling of CO2, alleviating the greenhouse effect and positively contributing to the achievement of the carbon neutrality target. The steam generator is used for providing water vapor, the CO2 storage tank is used for providing CO2, the feedstock gas mixing chamber is used for mixing water vapor and CO2, and the water vapor flow meter, the CO2 flow meter and the feedstock gas flow meter are disposed to conveniently control the ratio of water vapor/CO2 and the flow of the feedstock gas into the reversible solid oxide cell 1.

Preferably, the feedstock gas supply device 2 includes a feedstock gas circulating pipeline (not shown in the figure), and the exterior of the feedstock gas circulating pipeline is sleeved with a heat insulation pipe (not shown in the figure).

Disposing the heat insulation pipe of the present disclosure is conducive to improving the heat insulation and thermal insulation performance of the feedstock gas circulating pipeline, which is conducive to prolonging the service life of the feedstock gas circulating pipeline and reducing the cost. Specifically, the heat insulation pipe is a ceramic pipe; the feedstock gas circulating pipeline is a stainless steel pipeline.

In an optional implementation mode of the present disclosure, coal in the biomass/coal includes solid fossil fuel such as low-quality coal, and biomass in the biomass/coal includes straw, wood chips, rice husk or tree branches, and other biomass materials that are easy to obtain and low in cost.

In the above way, the addition of coal as an auxiliary material can, on the one hand, compensate for the shortage of biomass feedstock due to seasonal differences and meet the long-term stable operation of the system, and on the other hand, improve the stability of the quality of gasification products and meet the requirements of controllability and optimization of the coupling process of a multi-reaction system. Straw, wood chips, rice husk or tree branches are all renewable energy, and the use of the renewable energy is conducive to protecting the environment, coping with climate change, realizing green production, and conforming to the concept of sustainable development.

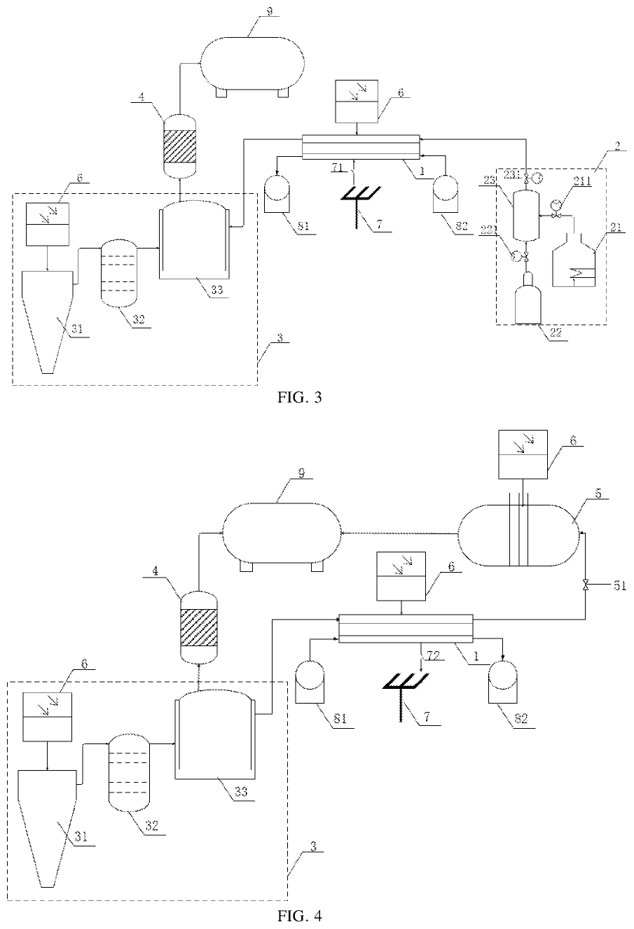

Further, in an optional implementation mode of the present disclosure, the synthesis gas supply device 3 further includes a gas purification device 32 and a synthesis gas storage tank 33. The gas purification device is used for absorbing CO2 and H2O, and an inlet of the gas purification device 32 is connected to an outlet of the gasification reaction chamber 31, and an outlet of the gas purification device 32 is connected to a first inlet of the synthesis gas storage tank 33. During electrolysis, a second inlet of the synthesis gas storage tank 33 is connected to the outlet of the fuel electrode 12, and during power generation, at least one outlet of the synthesis gas storage tank 33 is connected to the inlet of the fuel electrode 12. Specifically, a second outlet of the synthesis gas storage tank 33 is connected to the inlet of the fuel electrode 12; As shown in FIG. 1 and FIG. 3, during electrolysis, the right side of the fuel electrode 12 is the inlet and the left side of the fuel electrode 12 is the outlet; as shown in FIG. 1 and FIG. 4, during power generation, the left side of the fuel electrode 12 is the inlet and the right side of the fuel electrode 12 is the outlet. During electrolysis or power generation, the first outlet of the synthesis gas storage tank 33 is always connected to the inlet of the synthesis reactor 4, so that the synthesis gas can continuously enter the synthesis reactor 4 for reaction.

In the above way, the gas purification device 32 is disposed, which can remove CO2 and H2O mixed in the synthesis gas, and is conducive to improving the purity of the synthesis gas. Specifically, the gas purification device 32 is a tank filled with quicklime inside. Disposing the synthesis gas storage tank 33 makes it convenient to store the produced synthesis gas of a first source and synthesis gas of a second source for standby use, which improves convenience.

Specifically, the number of the reversible solid oxide cell 1 can be from 1 to more, and when the number of the reversible solid oxide cell 1 is greater than 1, the reversible solid oxide cells 1 are connected to the synthesis gas storage tank 33 in series or in parallel.

In the above way, the plurality of reversible solid oxide cells 1 are disposed to enable simultaneous production of the synthesis gas, and the synthesis gas produced by the plurality of reversible solid oxide cells 1 is introduced into the single synthesis gas storage tank 33, which is conducive to improving the yield and production efficiency of the synthesis gas. It is also capable of carrying out simultaneous power generation, the reversible solid oxide cell 1 and the photo-thermal coupled catalytic reactor 5 of the present disclosure can be disposed in a many-to-one manner, with mixed gas produced by the plurality of reversible solid oxide cells 1 introduced into the single photo-thermal coupled catalytic reactor 5, reducing the complexity of the system of the present disclosure.

Specifically, both the fuel electrode 12 and the oxygen electrode 11 are porous metal-ceramic members. The materials of the porous metal-ceramic members include zirconia-loaded nickel, a porous lanthanum-strontium-manganese compound, nickel-doped yttrium-stabilized zirconia, highly electrochemically active cobalt-based perovskite, etc. Further, as shown in FIG. 2, the reversible solid oxide cell 1 of the present disclosure further includes an electrolyte 13, and the electrolyte 13 is provided between the oxygen electrode 11 and the fuel electrode 12. The electrolyte 13 is a dense ceramic member, and the materials of the dense ceramic member include yttrium-stabilized zirconia, samarium-doped cerium oxide, etc.

In the implementation mode of the present disclosure, the right outlet of the fuel electrode 12 is provided with a mixed gas switch 51 controlling the on/off of the mixed gas. During power generation, the mixed gas (CO2, H2O, CO, H2) flowing out of the right outlet of the fuel electrode 12 enters the photo-thermal coupled catalytic reactor 5, the solar energy provides light and heat, and the hydrocarbon fuel is produced by the photo-chemical/thermal-chemical coupling process, which basically realizes zero carbon emission of the whole system, and is of significant significance for the control of the greenhouse effect.

In an implementation mode of the present disclosure, the solar energy is provided by a solar light condensation, heat collection and heat storage device 6, and the solar light condensation, heat collection and heat storage device 6 is in a tower, tank or butterfly type.

Further, the solar light condensation, heat collection and heat storage device 6 can achieve high-grade storage of the fluctuating solar energy, and can further achieve the controlled release of thermal energy and the optimization of energy flow within a composite system through the thermal-chemical process, providing a suitable temperature for each reaction.

The solar light condensation, heat collection and heat storage device of the present disclosure can provide the heat source required for the gasification reaction chamber 31 and the reversible solid oxide cell 1, and the heat source and light source required for the reaction of the photo-thermal coupled catalytic reactor 5, the energy source has the advantages of universality, harmlessness, large storage capacity and long-lasting use, etc. The solar light condensation, heat collection and heat storage device 6 can store the excess thermal energy and use it when the solar energy is not sufficient, improving the utilization rate of energy, being conducive to reducing the production cost and having significant economic benefits.

Further, in a preferable implementation mode of the present disclosure, the power of unstable renewable energy from the abandoned wind and light is provided by a power grid 7, the power grid 7 includes an input pipeline and an output pipeline, the output pipeline is provided with a first electrical switch 71, the input pipeline is provided with a second electrical switch 72, and the first electrical switch controls the on/off of the power of unstable renewable energy from abandoned wind and light to the electric energy delivered to the reversible solid oxide cell 1. The second switch controls the on/off of the electrical energy of the reversible solid oxide cell delivered to the power grid, and the electrical energy delivered to the power grid can be used for peak and frequency regulation to improve the stability of the renewable energy power grid.

In the above way, it is convenient to deliver the electrical energy to the reversible solid oxide cell 1 and output the electrical energy for utilization to improve the utilization rate of energy.

In a preferred embodiment of the present disclosure, the voltage provided by the power of unstable renewable energy from abandoned wind and light is set to an adjustable operating voltage, and the current changes accordingly to facilitate controlling the efficiency of the electrochemical reaction within the reversible solid oxide cell 1, thereby regulating the efficiency of the electrochemical reaction within the reversible solid oxide cell 1 so as to obtain synthesis gas with an arbitrary H2/CO ratio at the outlet of the fuel electrode 12.

Further, the embodiment of the present disclosure further includes a fuel storage tank 9, and the outlet of the synthesis reactor 4 and the outlet of the photo-thermal coupled catalytic reactor 5 are respectively connected to the fuel storage tank 9, and the hydrocarbon fuel flowing out of the outlet of the synthesis reactor 4 and the outlet of the photo-thermal coupled catalytic reactor 55 enters the fuel storage tank 9 for storage.

The above specifies the structure of the system for complementarily coupling and orderly converting multi-energy of the present disclosure, and the working principle thereof is described below.

As shown in FIG. 3, when the reversible solid oxide cell 1 is electrolyzed, the mixed gas switch 51 and the second electrical switch 72 are turned off, and the feedstock gas flow meter switch 231 and the first electrical switch 71 are turned on.

The feedstock gas (CO2 and H2O) provided by the feedstock gas supply device 2 has an electrochemical reaction at the fuel electrode 12 of the reversible solid oxide cell 1 to produce the synthesis gas (CO and H2), and the synthesis gas enters the synthesis gas storage tank 33 from the outlet of the fuel electrode 12. The air provided by the oxygen-poor air storage tank 82 enters the oxygen electrode 11 and is able to purge the oxygen produced on the surface of the oxygen electrode 11 and then enters the oxygen-rich air storage tank 81.

Biomass/coal gasifies in the gasification reaction chamber 31 to produce a certain percentage of gaseous fuel such as CO and H2. The produced gaseous fuel passes through the gas purification device 32 to remove CO2 and H2O to obtain pure synthesis gas, and the pure synthesis gas enters the synthesis gas storage tank 33.

The synthesis gas in the synthesis gas storage tank 33 further enters the synthesis reactor 4 to react to produce the hydrocarbon fuel, and the produced hydrocarbon fuel enters the fuel storage tank 9 for storage.

As shown in FIG. 4, when the reversible solid oxide cell 1 generates power, the second electrical switch 72 and the mixed gas switch 51 are turned on, the feedstock gas flow meter switch 231 and the first electrical switch 71 are turned off.

The biomass/coal gasifies in the gasification reaction chamber to produce a certain percentage of gaseous fuel such as CO and H2. The produced gaseous fuel passes through the gas purification device 32 to remove CO2 and H2O to obtain pure synthesis gas, and the pure synthesis gas enters the synthesis gas storage tank 33. A part of the synthesis gas in the synthesis gas storage tank 33 enters the synthesis reactor 4 through the first outlet to react to produce the hydrocarbon fuel. The hydrocarbon fuel produced by the synthesis reactor 4 and the hydrocarbon fuel produced by the photo-thermal coupled catalytic reactor 5 enter the fuel storage tank 9 for storage. A part of the synthesis gas in the synthesis gas storage tank 33 enters the fuel electrode 12 through the second outlet to produce CO2 and H2O by oxidization and stable electrical energy is output, and the CO2 and H2O produced at the fuel electrode 12 and the partially unreacted CO and H2 in the reversible solid oxide cell 1 enter the photo-thermal coupled catalytic reactor 5 through the mixed gas switch 51 to react to produce the hydrocarbon fuel. Oxygen in the air provided by the oxygen-rich air storage tank 81 enters the oxygen electrode 11 to have an electrochemical reaction, and gas after reaction enters the oxygen-poor air storage tank 82.

The present disclosure further provides a conversion method of the system for complementarily coupling and orderly converting multi-energy, including the following steps:
a synthesis gas production step, the gasification reaction chamber 31 providing synthesis gas of a first source through gasification of biomass/coal, and heat required for the gasification of the biomass/coal being provided by solar energy; the reversible solid oxide cell 1 being used as an electrolysis cell, power of unstable renewable energy from abandoned wind and light and solar energy respectively providing electrical energy and thermal energy required for electrolysis of the reversible solid oxide cell 1, and feedstock gas having an electrochemical reaction at the fuel electrode to produce synthesis gas of a second source; and
a hydrocarbon fuel production step, the synthesis gas of a first source and the synthesis gas of a second source reacting in the synthesis reactor 4 to produce hydrocarbon fuel; the reversible solid oxide cell 1 being used as a cell, the synthesis gas of a first source and/or the synthesis gas of a second source having an electrochemical reaction at the fuel electrode 12 and a produced product reacting with unreacted synthesis gas by entering the photo-thermal coupled catalytic reactor 5 to produce hydrocarbon fuel; a heat source and light source required for the photo-thermal coupled catalytic reactor 5 being provided by the solar energy.

The present disclosure provides a stable heat source for the gasification reaction of biomass/coal through the solar heat condensation, heat collection and heat storage device 6, without a combustion section for supplying heat and without sufficient oxygen supply, effectively improving the H/C ratio of the synthesis gas and facilitating the synthesis of hydrocarbon fuel such as methanol. CO2/H2O is electrolyzed to produce the synthesis gas by using the power of unstable renewable energy from abandoned wind and light and the stable heat source provided by the solar heat condensation, heat collection and heat storage device 6 to achieve recycling of CO2 and consumption of the power of unstable renewable energy from abandoned wind and light. Through photo-chemical/thermal-chemical coupling, by efficient catalytic reduction, CO/CO2/H2O/H2 discharged from the reversible solid oxide cell 1 after power generation is synthesized into hydrocarbon fuel with a high added value, such as methanol, basically realizing the system with no carbon emission and higher conversion efficiency for energy utilization.

The description is only preferred embodiments of the present disclosure and not intended to limit the present disclosure. Any modification, equivalent replacement, or improvement made within the spirit and principle of the present disclosure shall fall within the protection scope of the present disclosure.

1. A system for complementarily coupling and orderly converting multi-energy, comprising:
a gasification reaction chamber, the gasification reaction chamber providing synthesis gas of a first source through a gasification reaction of biomass/coal;
a reversible solid oxide cell, during electrolysis, an inlet of a fuel electrode of the reversible solid oxide cell being connected to a feedstock gas supply device, feedstock gas being electrolyzed at the fuel electrode to produce synthesis gas of a second source;
a synthesis reactor, the synthesis gas of a first source and the synthesis gas of a second source reacting in the synthesis reactor to produce hydrocarbon fuel; and
a photo-thermal coupled catalytic reactor, during power generation, the photo-thermal coupled catalytic reactor being connected to an outlet of the fuel electrode of the reversible solid oxide cell, an outlet of the gasification reaction chamber being connected to the inlet of the fuel electrode, and gas flowing out of the fuel electrode passing through the photo-thermal coupled catalytic reactor to react to produce hydrocarbon fuel;
wherein a heat source required for the gasification reaction chamber and the reversible solid oxide cell, and a heat source and light source required for the photo-thermal coupled catalytic reactor are provided by solar energy, and electrical energy required for electrolysis of the reversible solid oxide cell is provided by power of unstable renewable energy from abandoned wind and light.

2. The system for complementarily coupling and orderly converting multi-energy according to claim 1, further comprising: an oxygen-rich air storage tank and an oxygen-poor air storage tank, wherein during electrolysis, air flows from an outlet of the oxygen-poor air storage tank into the oxygen-rich air storage tank via an oxygen electrode; during power generation, air flows from an outlet of the oxygen-rich air storage tank into the oxygen-poor air storage tank via the oxygen electrode.

3. The system for complementarily coupling and orderly converting multi-energy according to claim 1, wherein the feedstock gas comprises water vapor and carbon dioxide;
the feedstock gas supply device comprises a steam generator, a CO₂ storage tank and a feedstock gas mixing chamber, the steam generator and the CO₂ storage tank are respectively connected to the feedstock gas mixing chamber, and a water vapor flow meter, a CO₂ flow meter and a feedstock gas flow meter are respectively connected to an outlet pipeline of the steam generator, the CO₂ storage tank and the feedstock gas mixing chamber.

4. The system for complementarily coupling and orderly converting multi-energy according to claim 1, wherein coal in the biomass/coal comprises low-quality coal, and biomass in the biomass/coal comprises straw, wood chips, rice husk or tree branches.

5. The system for complementarily coupling and orderly converting multi-energy according to claim 1, further comprising, a gas purification device and a synthesis gas storage tank;
wherein the gas purification device is used for absorbing CO₂ and H₂O, and an inlet of the gas purification device is connected to the outlet of the gasification reaction chamber, and an outlet of the gas purification device is connected to a first inlet of the synthesis gas storage tank;
during electrolysis, a second inlet of the synthesis gas storage tank is connected to the outlet of the fuel electrode, and during power generation, an outlet of the synthesis gas storage tank is connected to the inlet of the fuel electrode.

6. The system for complementarily coupling and orderly converting multi-energy according to claim 5, wherein the number of the reversible solid oxide cell can be from 1 to more, and when the number of the reversible solid oxide cell is greater than 1, the reversible solid oxide cells are connected to the synthesis gas storage tank in series or in parallel.

7. The system for complementarily coupling and orderly converting multi-energy according to claim 1, wherein the power of unstable renewable energy from abandoned wind and light is provided by a power grid, the power grid comprises an input pipeline and an output pipeline, the output pipeline is provided with a first electrical switch, the input pipeline is provided with a second electrical switch, and the first electrical switch controls the on/off of the power of unstable renewable energy power from abandoned wind and light to the electric energy delivered to the reversible solid oxide cell; the second switch controls the on/off of the output of the electrical energy when the reversible solid oxide cell generates power.

8. The system for complementarily coupling and orderly converting multi-energy according to claim 1, wherein the solar energy is provided through a solar light condensation, heat collection and heat storage device, and the solar light condensation, heat collection and heat storage device is in a tower, tank or butterfly type.

9. The system for complementarily coupling and orderly converting multi-energy according to claim 1, further comprising: a fuel storage tank, an outlet of the photo-thermal coupled catalytic reactor and an outlet of the synthesis reactor being respectively connected to the fuel storage tank.

10. A conversion method comprising:
using a system to complementarily couple and orderly convert multi-energy, wherein the system comprises:
a gasification reaction chamber, the gasification reaction chamber providing synthesis gas of a first source through a gasification reaction of biomass/coal;
a reversible solid oxide cell, during electrolysis, an inlet of a fuel electrode of the reversible solid oxide cell being connected to a feedstock gas supply device, feedstock gas being electrolyzed at the fuel electrode to produce synthesis gas of a second source;
a synthesis reactor, the synthesis gas of a first source and the synthesis gas of a second source reacting in the synthesis reactor to produce hydrocarbon fuel; and
a photo-thermal coupled catalytic reactor, during power generation, the photo-thermal coupled catalytic reactor being connected to an outlet of the fuel electrode of the reversible solid oxide cell, an outlet of the gasification reaction chamber being connected to the inlet of the fuel electrode, and gas flowing out of the fuel electrode passing through the photo-thermal coupled catalytic reactor to react to produce hydrocarbon fuel;
wherein a heat source required for the gasification reaction chamber and the reversible solid oxide cell, and a heat source and light source required for the photo-thermal coupled catalytic reactor are provided by solar energy, and electrical energy required for electrolysis of the reversible solid oxide cell is provided by power of unstable renewable energy from abandoned wind and light,
wherein using the system to complementarily couple and orderly convert multi-energy comprises:
the gasification reaction chamber providing the synthesis gas of the first source through the gasification reaction of the biomass/coal, and heat required for the gasification of the biomass/coal being provided by the solar energy; the reversible solid oxide cell being used as an electrolysis cell, the power of unstable renewable energy from the abandoned wind and light and the solar energy respectively providing the electrical energy and the thermal energy required for the reversible solid oxide cell, and the feedstock gas having an electrochemical reaction at the fuel electrode to produce the synthesis gas of the second source; and
the synthesis gas of the first source and the synthesis gas of the second source reacting in the synthesis reactor to produce the hydrocarbon fuel; the reversible solid oxide cell being used as the electrolysis cell, the synthesis gas of the first source and/or the synthesis gas of the second source having an electrochemical reaction at the fuel electrode, and a produced product reacting with unreacted synthesis gas by entering the photo-thermal coupled catalytic reactor to the produce hydrocarbon fuel; the heat source and the light source required for the photo-thermal coupled catalytic reactor being provided by the solar energy.
